(19) United States
(12) Patent Application Publication
(10) Pub. No.: US 2009/0139173 A1
(43) Pub. Date: Jun. 4, 2009

(54) Wlikins shutter assembly

(76) Inventor: Benjamin Wilkins, Helendale, CA (US)

Correspondence Address: Ira J. Nasserian, Ste 700, 5757 W. Century Blvd., Los Angeles, CA, 90045, US

(21) Appl. No.: 11/998,649

(22) Filed: Nov. 30, 2007

(51) Int. Cl. E06B 7/08

(52) U.S. Cl. 52/473

(57) ABSTRACT

A shutter system is disclosed which is unitized in a single rectangular frame or bracket with a window or door for use in a building opening that includes a plurality of shutter plates that can be folded and unfolded, each of the shutter plates having a hinged joint with adjoining shutter plates. The shutter assembly shields an enclosure from environmental elements. The rectangular bracket has guide members with tracks for guiding the shutter plates using extensions with rollers from each of the hinged joints to cooperate with the guide members. In one embodiment, the moveable flat plats slides behind the stationary flat plats. In another embodiment, the moveable flat plats are collected at one side of the rectangular frame providing maximum opening of the enclosure.

### FIELD OF THE INVENTION

The present invention relates to a shutter assembly with actuation system that enables a more complete manipulation and closure of a window resulting in a more precise operation allowing a more complete light or air passage or blockage into a closed structure.

### BACKGROUND OF THE INVENTION

Window shutters have been in use for a long time and are well known in the construction industry. The use of shutters is many folds among which are to shield the interior of a structure from light, dust, hot or cold air and also in many occasions such protective means are used for decorative purposes and ensuring privacy of inhabitants of the enclosure.

Early shutters were typically made out of wood and were subject to assortment of problems such as rotting, warpage and dimensional changes due to moisture absorption. The introduction of polyvinyl chloride (PVC) to replace wood in manufacturing shutter was a partial response to rotting of wooden material. The use of PVC in manufacture of shutter added a new wrinkle resulting from lack of strength and structural stability. Such problems have been addressed in U.S. Pat. No. 5,941,021, in which the invention provided a means to reinforce the louvered slats with a metal bar. However, the type of reinforcement suggested in this design is costly, difficult to manufacture, and introduces added weight to the system.

Another window covering shutter is the type which folds over window and door and have been in use for a long time. The louvers of the shutter are either fixed or pivoting. Pivoting louvers are typically hinged at their end points by a pair of projections which mate with a pair of bearing bores. The louvers are installed vertically or horizontally which in and of itself introduces another problem of light or dust passing between the adjacent pairs of louvers. While these shutters are designed to provide light control and privacy, they often cover the beauty of the window itself as well as minimize the viewer's ability to see through the window.

Drape is another type of window covering that is extensively used to provide privacy for residents of a residential enclosure or to protect the enclosure from the environmental elements. A functional advantage of Drapes is that drapes can be positioned to allow a desired light level and also to deflect light and to deflect glare. Drapes also serve to reduce heat load transferred to the interior area of an enclosure through a window opening. However, drapes do not control the measure of light or heat transfer into and enclosure or environmental elements to a desired level. A user of conventional drapes can position a drape so either all lights are let in or no light is allowed in the enclosure. The best means of controlling a measure of air or light into an enclosure is to position the drapes awkwardly between a fully open and fully closed position.

The problems enumerated above requires a high degree of precise positioning and control of a shutter assembly which can block out the least amount of dust, light and provide a high degree of privacy to habitants of a structure.

Therefore, a need exists for an improved shutter system that provides a user with high degree of privacy, and exposes the habitants of an enclosed structure with minimum amount of dust, light and a high degree of control over the amount of air passing through the window. Still another need exist for a shutter that can provide protective advantages enumerated above as well as being aesthetically pleasant and in conformity with the enclosure's decoration and allow for more of the window and the view outside the window to be seen.

### SUMMARY OF THE INVENTION

Accordingly, embodiments of the present invention provide a user with various shutters assembly that are convenient to operate, aesthetically attractive, while efficiently controlling passage of air, dust, noise and light into or out of an enclosure.

One embodiment of the present invention provides a user with a shutter assembly that is comprised of a number of flat plats made of hard material (e.g., wood, plastic, etc. . . . ). According to this embodiment of the present invention, the shutter assembly comprises of a number of fixed non-pivoting flat plats where every other flat plat is a stationary flat plat or a moveable flat plats. The user can move the moveable flat plats upwardly or downwardly. The shutter assembly is in its open position when the moveable flat plats are moved either upwardly or downwardly and are positioned behind the stationary flat plats of the shutter assembly. Positioning the moveable flat plats behind the stationary flat plats provides a number of apertures between two adjacent stationary flat plats through these apertures air, and light can flow in and out of an enclosure protected by the shutter assembly. Additional layers of flat plats can be added to combine hard and soft covering. A third layer of flat plat can be manufactured to be either in stationary position or movable position from screen material to provide a third layer. A user can actuate this third layer to enhance privacy and light control when positioned between the stationary layer and two moveable layers.

It is appreciated that stationary flat plats and moveable flat plat can be installed either substantially horizontal or substantially vertical. In case where moveable flats plats and stationary flat plats are installed substantially vertical, the user can move the moveable flat plats relative to stationary flat plats eastwardly or westwardly. Such movement of moveable flat plats results in a number of apertures through these apertures air, and light can flow freely. In another similar configuration moveable flat plats can stack or layer behind each other in increments greater than one and come to rest in the full open position behind a stationary flat plat, (i.e., in this embodiment every fourth flat plat could be stationary while three moveable flat plats are raised or lowered, slid left or right plat one behind plat two then the first two plats behind the third then finally the three plats together behind the stationary fourth flat plat.

The preferred embodiment of the present invention discloses a shutter assembly including a plurality of interconnected pivotal slats; the slat assembly is loosely connected to a railing imbedded in the window frame vertically or horizontally. This loose connection allows the pivotal slats to rest upon each other, to rest evenly spaced from each other, or to rest at any point between the fore mentioned positions. The interconnected pivotal slats may be arranged to layer in multiples, to collect entirely at the top, to collect entirely at the bottom, or to collect half at the top and half at the bottom. According to one embodiment of the present invention the shutter assembly is installed inside the window opening of a structure. When shutter assembly comprises of flat plats installed horizontally, the horizontally installed flat plats may be drawn up or down to provide a measure of opening to the enclosure from a fully open condition or partially open condition. The horizontally installed shutter assembly can measurably close the window opening when the plurality of the flat plats are drawn closed and tilted to a fully up, partially closed, or fully closed position.

Still in another preferred embodiment of this invention the flat plats are vertically installed inside the shutter assembly. The vertically installed shutter assembly provides a measure of opening to the enclosure when the pluralities of flat plats are fully rolled to the side of the window frame in a tilted condition. The vertically installed shutter assembly selectively closes the window opening if the plurality of the slats are rolled to the sides of the window frame and tilted to an open, partially closed, or fully closed position.

These and other objects and advantages of the present invention will no doubt becomes obvious to those of ordinary skill in the art after having read the following detailed description of the preferred embodiments which are illustrated in the various drawing figures.

### BRIEF DESCRIPTION OF THE DRAWINGS

Picture 1A depicts a front view of an embodiment of the present invention with moveable flat plats in an open position.

FIG. 1B illustrates a side view of an embodiment of the present invention with moveable flat plats positioned behind the stationary flat plats.

FIG. 1C illustrates a front view of an embodiment of the present invention with moveable flat plats moved partially upward or downward to control measure of opening of the window.

FIG. 1D depicts a side view of an embodiment of the present invention where the flat plats are moved upwardly or downwardly and are placed substantially between the stationary flat plats to close the opening of the window.

FIG. 2A illustrates a front view of an embodiment of the present invention where a plurality of moveable flat plats is used to control the window opening.

FIG. 2B illustrates a side view of an embodiment of the present invention where a plurality of moveable flat plats is placed substantially behind the stationary flat plat to maximize the window opening.

FIG. 2C depicts another embodiment of the present invention where a plurality of moveable flat plats are used and one of the plurality of flat plats is positioned between the stationary flat plats to partially block the flow of air or light.

FIG. 2D illustrates the side view of an embodiment of the present invention where one of the plurality of the flat plats is used to prevent flow of air, light and dust into the enclosure.

FIG. 2E illustrates the front view of an embodiment of the present invention where the plurality of moveable flat plats are positioned between the stationary flat plat to minimize the flow of air, light and dust flow into the enclosure.

FIG. 2F illustrates the side view of an embodiment of the present invention where the plurality of moveable flat plats are positioned between the stationary flat plat to minimize the flow of air, light and dust flow into the enclosure

FIG. 3A illustrates an embodiment of the present invention where a plurality of flat plats is moved manually and is in its open position to maximize flow of light, air, and dust into the enclosure.

FIG. 3B depicts the side view of FIG. 3A.

FIG. 3C depicts the front view of another embodiment of the present invention where the plurality of movable flat plats are rotated to a closed position preventing flow of air, light and dust into the enclosure.

FIG. 3D depicts the side view of FIG. 3C

FIG. 4A depicts side view of one flat plat of the plurality of flat plats each having a first and a second end and each end attached to a pin.

FIG. 4B is the front view of the flat plat described in FIG. 4A.

FIG. 4C illustrates the front view of the preferred embodiment of the present invention with a plurality of moveable flat plats in an open position.

FIG. 5 illustrates the front view of the preferred embodiment of the present invention with a plurality of flat plats tilted to a vertical position closing the window opening.

FIG. 6 depicts another embodiment of the present invention where flat plats are installed in a horizontal position and at least one flat plat of the plurality of the flat plat is moved close to the top of the frame and the rest are moved substantially against the bottom of the frame.

FIG. 7 depicts another embodiment of the present invention where a plurality of flat plats are installed inside a window frame having a top side and a bottom side and the plurality of flat plats are move substantially next to the top side of the window opening.

FIG. 8 depicts another embodiment of the present invention where a plurality of flat plats are installed inside a window frame having a top side and a bottom side and the plurality of flat plats are move substantially next to the bottom side of the window opening.

FIG. 9 depicts another embodiment of the present invention where flat plats are installed in a vertical position and at least one flat plat of the plurality of the flat plat is positioned close to one side of the frame and the rest are positioned substantially against the other side of the frame.

FIG. 10 depicts another embodiment of the present invention where flat plats are installed in a vertical position and at least one flat plat of the plurality of the flat plat is positioned close to one side of the frame and the rest are positioned substantially against the other side of the frame.

FIG. 11 depicts another embodiment of the present invention where flat plats are installed in a vertical position and at least one flat plat of the plurality of the flat plat is positioned close to one side of the frame and the rest are positioned substantially against the other side of the frame.

### DETAILED DESCRIPTION OF THE DRAWINGS

Reference will now be made in detail to the preferred embodiments of the present invention, an efficient window shutter, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details.

In the following detailed description of the present invention, numerous specific details are set forth in order to provide a thorough understanding of the present invention. However, it will be recognized by one skilled in the art that the present invention may be practiced without these specific details or with equivalents thereof. In other instances, well known methods, procedures, and components have been described in detail as not necessarily obscure aspects of the present invention.

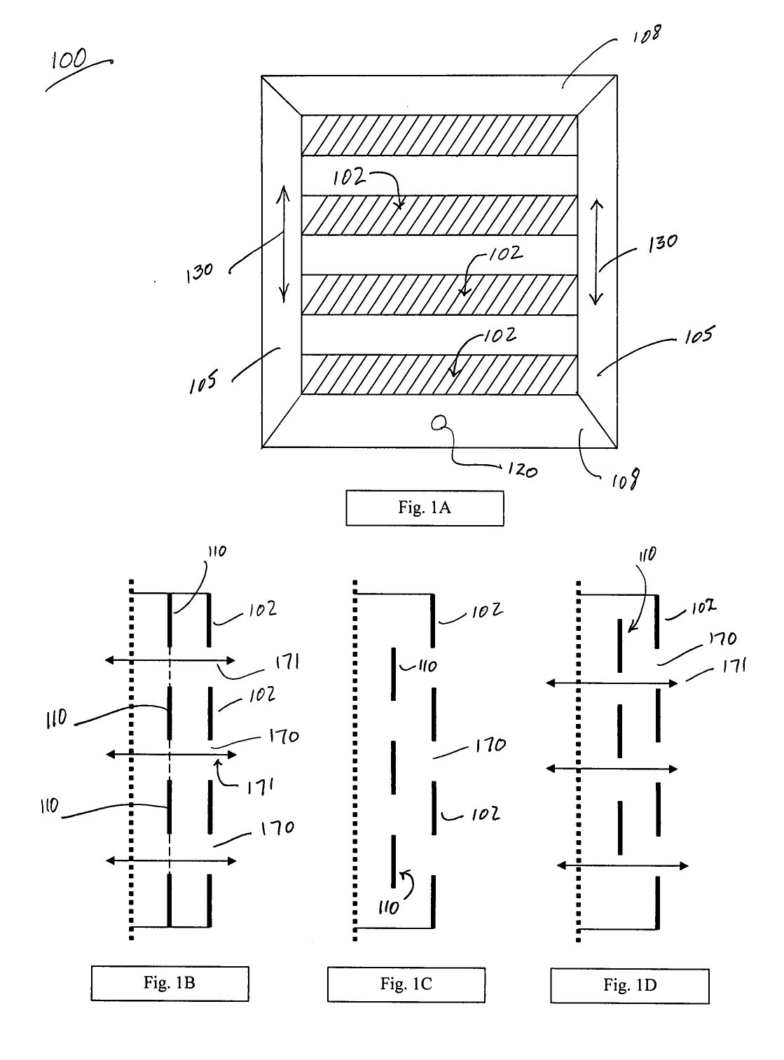

FIG. 1A depicts shutter assembly 100 that includes a plurality of stiles 105, a plurality of rails 108, a plurality of stationary flat plats 102 and at least one knob 120 for sliding down or sliding up the plurality of moveable flat plats 110 (not shown). Shutter assembly 100 generally is installed in a window frame or a door frame. The plurality of moveable flat plats 110 (not shown) are mechanically coupled to knob 120 and moveably coupled to the plurality of stiles 105. The plurality of stationary flat plats 102 is pivotally coupled to substantially vertical stiles 105. The plurality of moveable flats plats are interconnected and are slideable upwardly or downwardly along direction 130. Knob 120 is Rotatable clockwise or counterclockwise causing the plurality of the moveable flat plats 110 (not shown) slide upwardly or downwardly in direction 130. A user can slide the moveable flat plats 110 (not shown) substantially behind the plurality of the stationary flat plats 102 providing a plurality of aperture 170 shown in FIG. 1B. A user can cause the plurality of moveable flat plat 110 (not shown) to slide in the direction 130 to cause the aperture 170 to a fully open, partially closed, or fully closed position.

FIG. 1B illustrates a side view of shutter assembly 100, previously illustrated and described in FIG. 1A, in an open position. The shutter assembly 100 is in its open position when the plurality of moveable flat plats 110 are moved to a position substantially behind the stationary flat plats 102. The shutter assembly 100 in its open position provides a plurality of apertures 170. The plurality of apertures 170 allow passage of air, light, noise and dust flow into and out of an enclosure in direction 171 where shuttered assembly 100 is installed.

FIG. 1C illustrates side view of shutter assembly 100, an embodiment of the present invention, with the plurality of moveable flat plats 110 and a plurality of stationary flat plats 102. The plurality of moveable flat plats 110 is moveable upwardly or downwardly. Shutter assembly 100 is in a closed position when the plurality of moveable flat plats 110 is moved upwardly or downwardly and positioned substantially behind the stationary flat plats 102. In a closed position shutter assembly 100 prevents flow of air, light, heat and dust into and out of the enclosure where the shutter assembly 100 is installed.

FIG. 1D depicts side view of shutter assembly 100, an embodiment of the present invention, with the plurality of moveable flat plats 110 and a plurality of stationary flat plats 102. The plurality of moveable flat plats 110 is moveable upwardly or downwardly. Shutter assembly 100 is in a partially closed position when the plurality of moveable flat plats 110 is moved upwardly or downwardly and positioned partially behind the stationary flat plats 102. In a partially closed position the size of the plurality of aperture 170 is reduced as the result of movement of the plurality of moveable flat plats and the flow of air, light, heat and dust in direction 171 into and out of the enclosure, where the shutter assembly 100 is installed, is controlled.

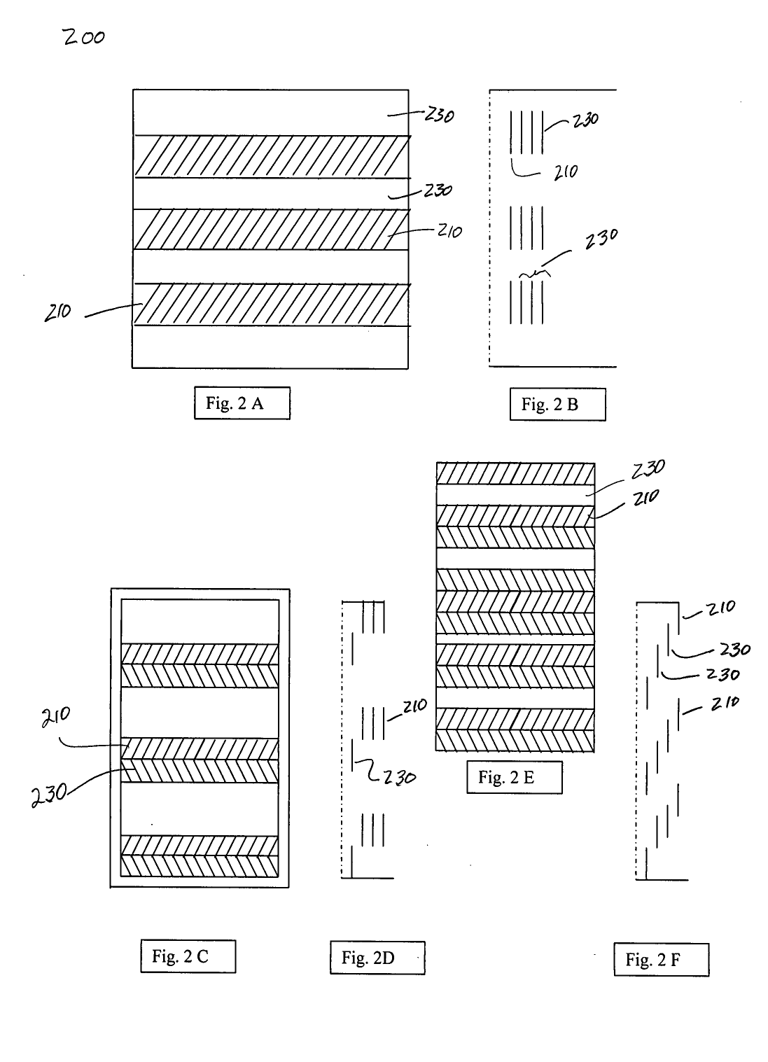

FIG. 2A illustrates front view of shutter assembly 200 an embodiment of the present invention comprising a plurality of stationary flat plats 210 and at least a plurality of moveable flat plats (not shown). The at least one plurality of flat plats is moveable upwardly or downwardly to control a plurality of aperture 220. According to this embodiment of the present invention the at least one plurality of flat plats are moved to a position substantially behind the plurality of stationary flat plats 210 providing maximum opening of a plurality of aperture 220.

FIG. 2B depicts a side view of shutter assembly 200 an embodiment of the present invention where at least one of the plurality of moveable flat plats 230 is placed substantially behind the stationary flat plats 210 to maximize the window opening. According to this embodiment of the present invention at least four plurality of moveable flat plats 230 are used to control the flow of air, dust, light and heat into and out of the enclosure where the shutter assembly 200 is installed.

FIG. 2C depicts shutter assembly 200 another embodiment of the present invention where a plurality of moveable flat plats 230 (shown in FIG. 2B) are used and one of the plurality of flat plats is positioned between the stationary flat plats 210 to partially block the flow of air, dust, heat and light.

FIG. 2D illustrates the side view of shutter assembly 200 another embodiment of the present invention where one of the plurality of the flat plats 230 (shown in FIG. 2B) is used to prevent flow of air, light and dust into the enclosure.

FIG. 2E illustrates the front view of shutter assembly 200 an embodiment of the present invention where the plurality of moveable flat plats 230 are positioned substantially between the stationary flat plats 210 to minimize the flow of air, light and dust into and out of the enclosure.

FIG. 2F illustrates the side view of shutter assembly 200 an embodiment of the present invention where at least four of the plurality of moveable flat plats 230 is positioned between the stationary flat plats 210 to minimize the flow of air, light and dust flow into the enclosure. The use of four of the plurality of moveable flat plats increases the degree in control of the size of the aperture 220. According to this embodiment of the present invention at least four of the plurality of moveable flat plats 230 are moved to substantially reduce the size of aperture 220 and prevent the flow of air, light, dust and heat into and out of the enclosure.

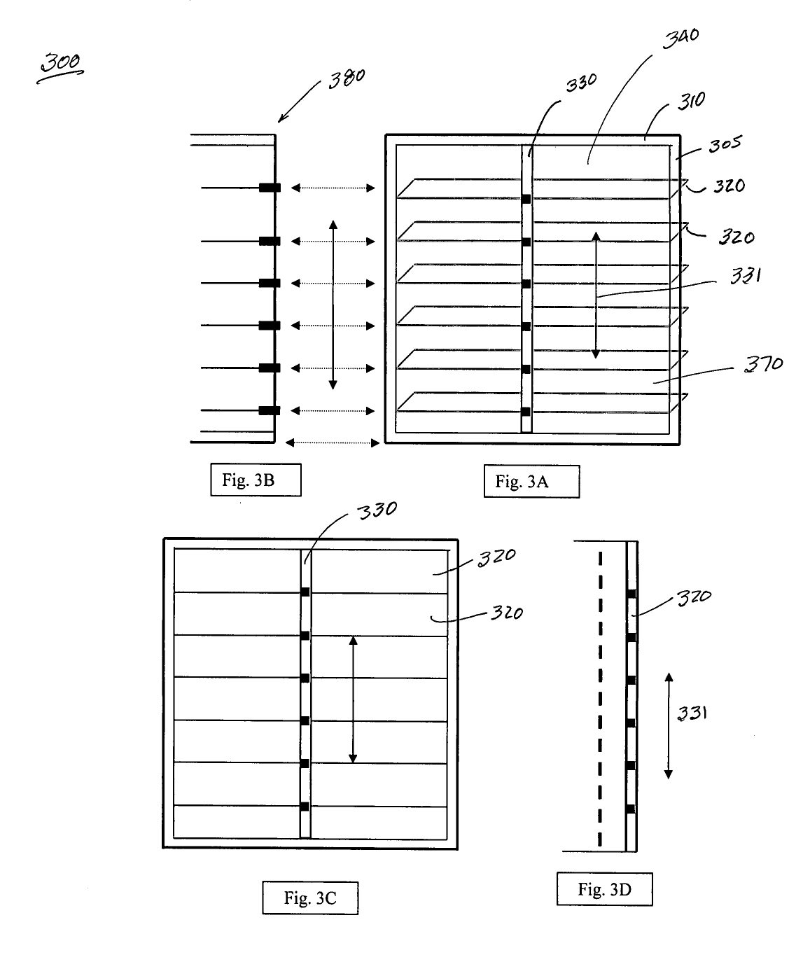

FIG. 3A illustrates shutter assembly 300 comprising a plurality of stiles 305, a plurality of rails 310, a plurality of moveable flat plats 320 a rectangular rod 330 and a mean for connection rectangular rod 330 to the plurality of flat plats 320 (not shown). The plurality of stiles 305 and the plurality of tiles 310 are tightly coupled to form window opening 340. The plurality of moveable flat plats 320 are loosely coupled to window opening 340. The rectangular rod 330 removeably coupled to the plurality of moveable flat plats 320. Rectangular rod 330 is manually movable upwardly or downwardly in the direction 331 to control the plurality of aperture 370. Movement of rectangular rod 330 tilts the plurality of moveable flat plats 320 in clockwise or counterclockwise direction and increases the opening of aperture 370 to control passage of light, air, heat and dust in or out of the enclosure where shutter assembly 300 is installed.

FIG. 3B depicts a side view of shutter assembly 300 in an open position. The plurality of moveable flat plats 320 is in a perpendicular position to window frame 380. In this position the plurality of aperture 370 are in their maximum opening to allow flow of air, light, dust and heat to flow in and out of the enclosure where the shutter assembly 300 is installed.

FIG. 3C depicts the front view of another embodiment of the present invention where the plurality of movable flat plats are rotated to a closed position preventing flow of air, light and dust into the enclosure.

FIG. 3D depicts the side view of shutter assembly 300 in a closed position. The rectangular rod 330 is moved upwardly or downwardly to position the plurality of flat plats 320 parallel to the face of the shutter assembly 300 such that the plurality of aperture 370 is to it minimum opening and thus there is no flow of air, dust, light, or heat in or out of the enclosure.

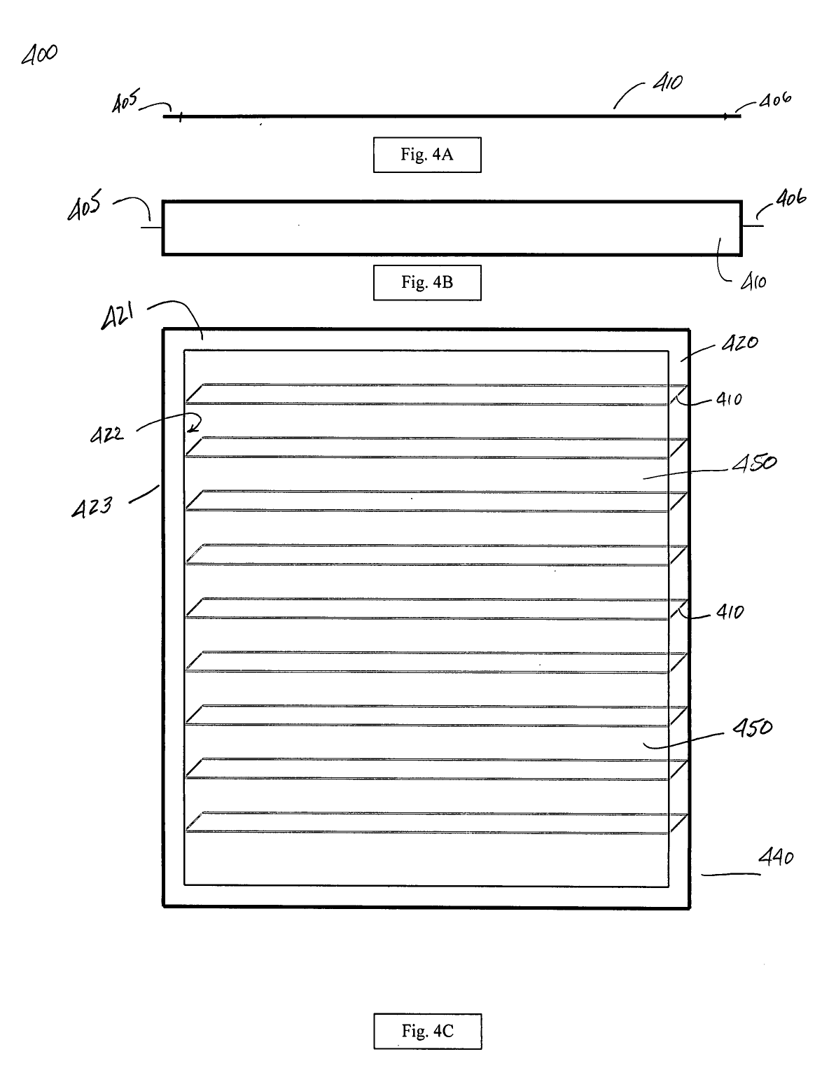

FIG. 4A depicts a side view of a rectangular flat plat 410 having a first and second side. Rectangular flat plat 410 includes coupling member 405 pivotally coupled to the first side and coupling member 406 pivotally coupled to the second side. Coupling members 405, and 406, serve as a horizontal axis about which the plurality of flat plat may be pivoted: to a horizontal position, that is the fully open position of the plat: to a vertical position, that is the fully closed position of the slat; or to a partially closed, intermediate position.

FIG. 4B illustrate a front view of the rectangular flat plat 400 of FIG. 4A having a first face 410 and a second face (not shown).

FIG. 4C illustrates the front view of the preferred embodiment of the present invention comprising the plurality of rotatable flat plats 410 illustrated in FIG. 4A and FIG. 4B, a plurality of stiles 420 and a plurality of rails 421. The plurality of stiles 420 are coupled to the plurality of rails 421 forming a rectangular frame 440. The rectangular frame 440 can be installed in any suitable manner to overlie the window (or door) opening of a building structure with which the shutter is to be used. The plurality of stiles 420 also include an inside face 422 and an outside face 423. The outside face of the plurality of the stiles 420 will be secured to a side of the window opening of a building structure. The inside face of the plurality of stiles 420 includes railing that can receive pin 405 or 406 of FIG. 4A. The plurality of rotatable flat plats 410 are pivotally coupled to Pin 405, 406 which serve as a horizontal axis about which each one of the plurality of rotatable flat plats 410 may be pivoted: to a horizontal position, which is fully open position of the flat plat: to a vertical position, which is the fully closed position of the slat; or to a partially closed, intermediate position. FIG. 4C depicts the preferred embodiment of the present invention when the plurality of rotatable flat plats 420 are in horizontal position providing a plurality of aperture 450 allowing air, light, dust etc. . . . to pass through the aperture 440.

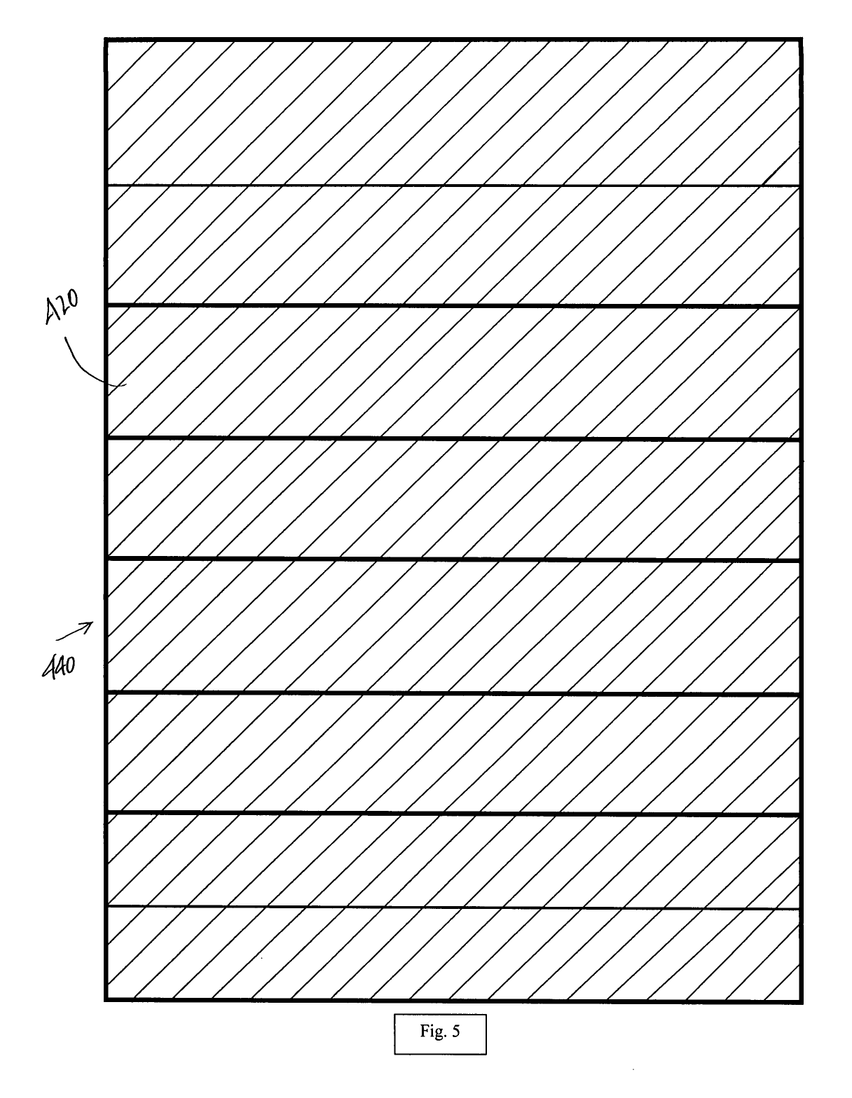

FIG. 5 illustrates the front view of the preferred embodiment of the present invention described in FIG. 4 when the plurality of the rotatable flat plats 420 are pivoted to a vertical position where the first face of each one of the plurality of flat plats 420 faces the inside of the enclosure and the second face of each one of the plurality of rotatable flat plats 420 faces outside of the enclosure thus substantially reducing the plurality of aperture 440 of FIG. 4C causing the window opening to a close position and resulting prevention of passage of air, light, dust etc. . . . through the window opening.

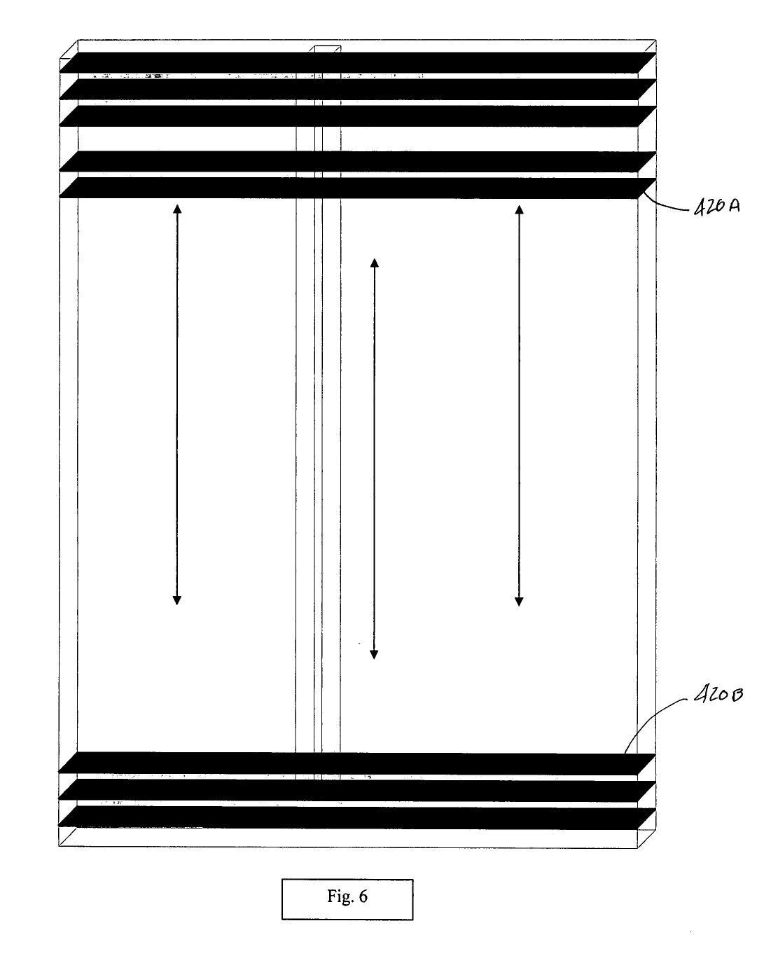

FIG. 6 depicts the front view of the preferred embodiment of the present invention where the plurality of rotatable flat plats 420 as described in FIG. 4 is divided in two groups 400A and 400B. The plurality of rotatable flat plats 420 are pivoted to a position perpendicular to the plane of window opening. A user can move the plurality of rotatable flat plats 400A upwardly and 400B downwardly. Movement of the plurality of rotatable flat plats 400A and 410B could be simultaneously or independently. The opening of the window opening is enlarged to the maximum allowing light and air to flow in and out of the enclosure.

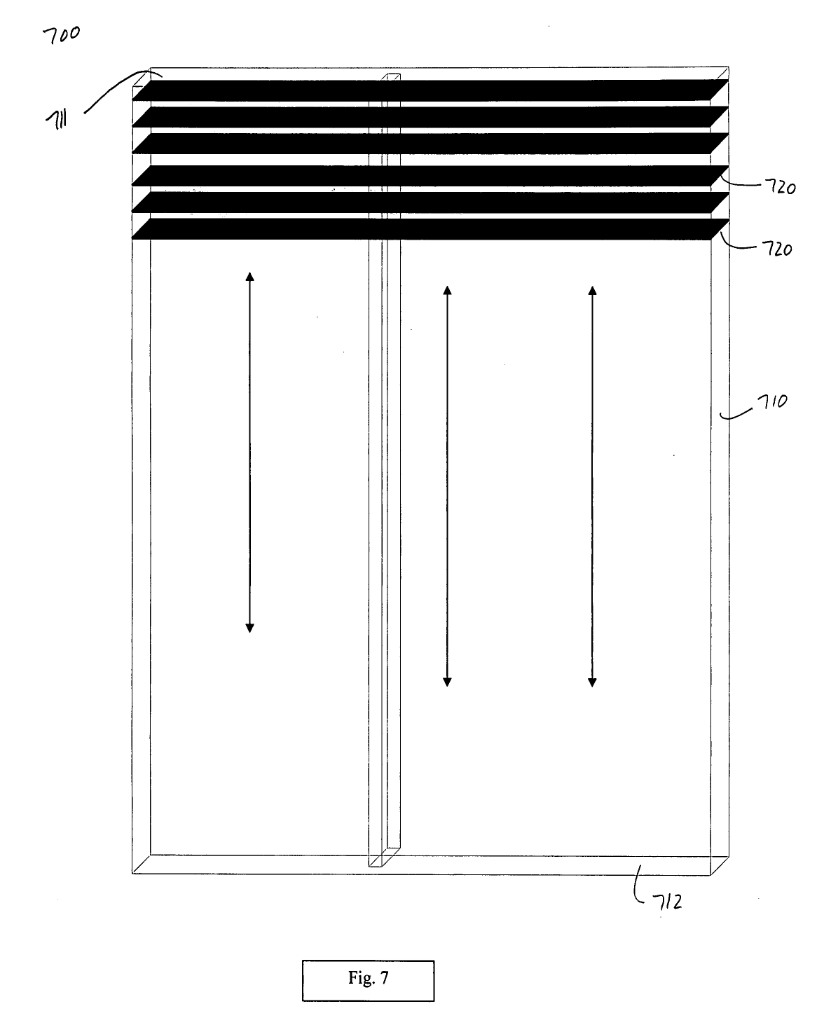

FIG. 7 illustrates shutter assembly 700 comprising frame 710 described under FIG. 1A, a plurality of rotatable flat plats described under FIG. 4C. Frame 710 has a top side 711 and a bottom side 712. The plurality of rotatable flat plats 720 include pins 405 and 406 (not shown) that can be received by the railing on the inner side of the frame as described in FIG. 4A. The plurality of flat plats 720 can be moved upwardly and positioned substantially close to the top side of the frame 710 or can be positioned substantially close to the bottom side of frame 710 next to the side 712. Accordingly the opening of the window is enlarged to the maximum allowing light and air to flow in and out of the enclosure.

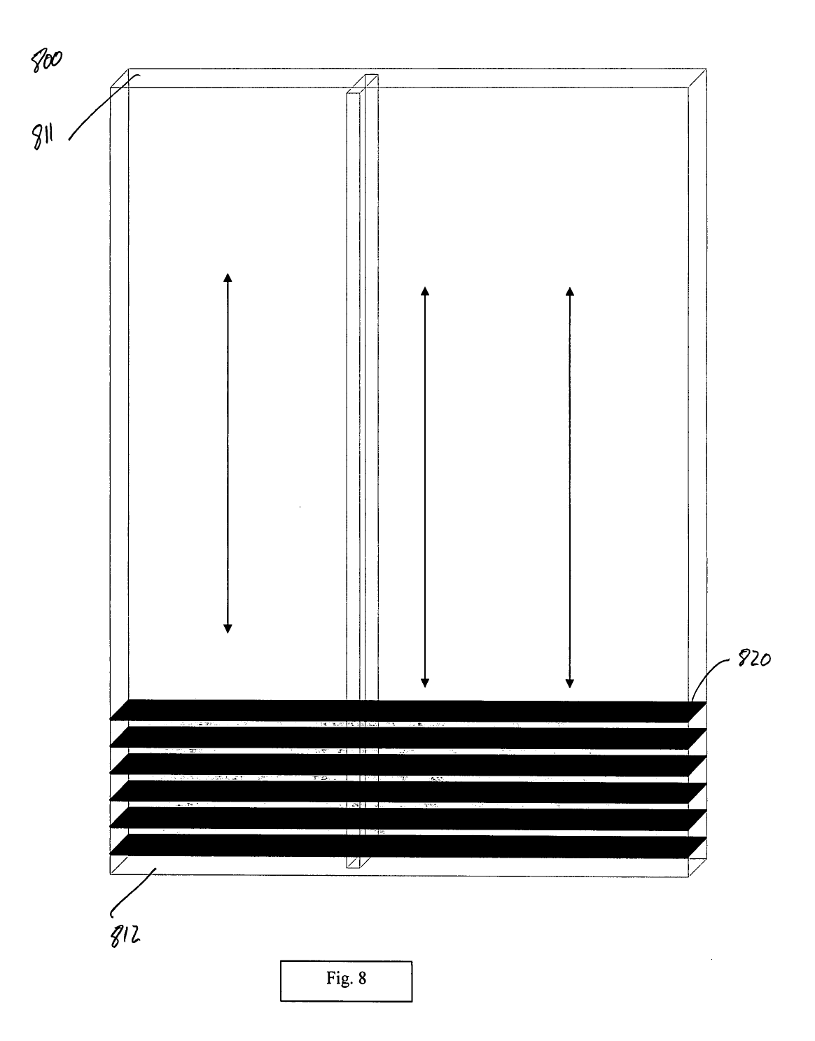

FIG. 8 illustrates shutter assembly 800 comprising frame 810 described under FIG. 7, a plurality of rotatable flat plats 720 described under FIG. 7. Frame 810 has a top side 811 and a bottom side 812. The plurality of rotatable flat plats 820 include pins 405 and 406 (not shown) that can be received by the railing on the inner side of the frame as described in FIG. 4A. The plurality of flat plats 820 can be moved substantially close to the bottom side of frame 810 next to the side 812. Accordingly the opening of the window is enlarged to the maximum allowing light and air to flow in and out of the enclosure.

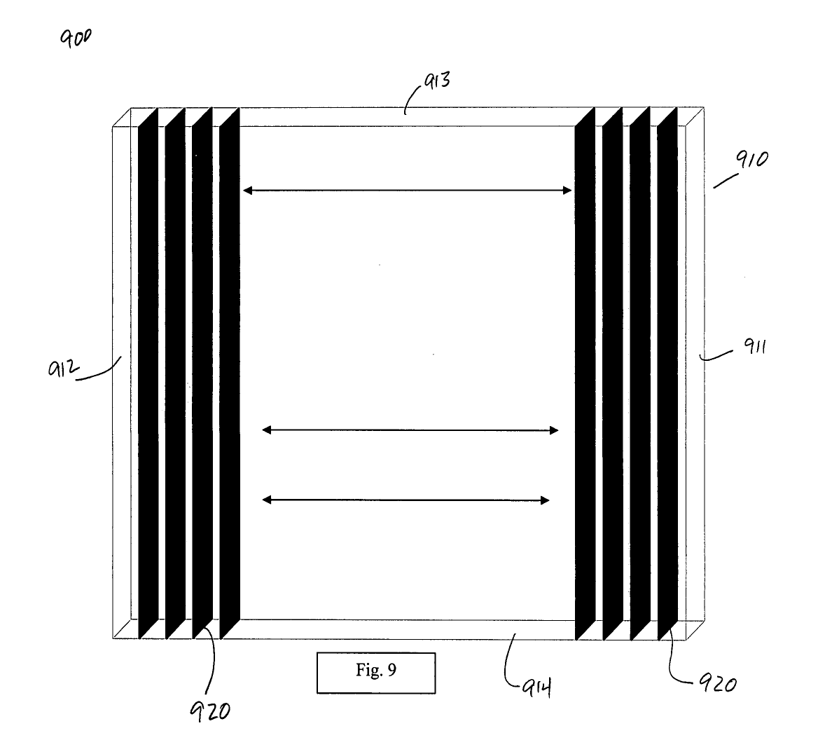

FIG. 9 illustrates shutter assembly 900 comprising window frame 910 described under FIG. 1A, a plurality of rotatable flat plats 920 described under FIG. 4C. Window Frame 910 has a right side 911, a left side 912 a top side 913 and a bottom side 914. According to this embodiment of the present invention the plurality of the plurality of flat plats 920 are loosely coupled to the top side of window frame 910. The plurality of rotatable flat plats 920 include pins 405 and 406 (not shown) that can be received by the railing on the inner side of the frame 910 as described in FIG. 4A. The pins 405 and 406 are received by the top side 913 and the bottom side 914. The plurality of flat plats 920 can be moved upwardly and positioned substantially close to the top side of the frame 910 next to the side 913 or can be positioned substantially close to the bottom side of frame 910 next to the side 914. Accordingly the opening of the window is enlarged to the maximum allowing light and air to flow in and out of the enclosure.

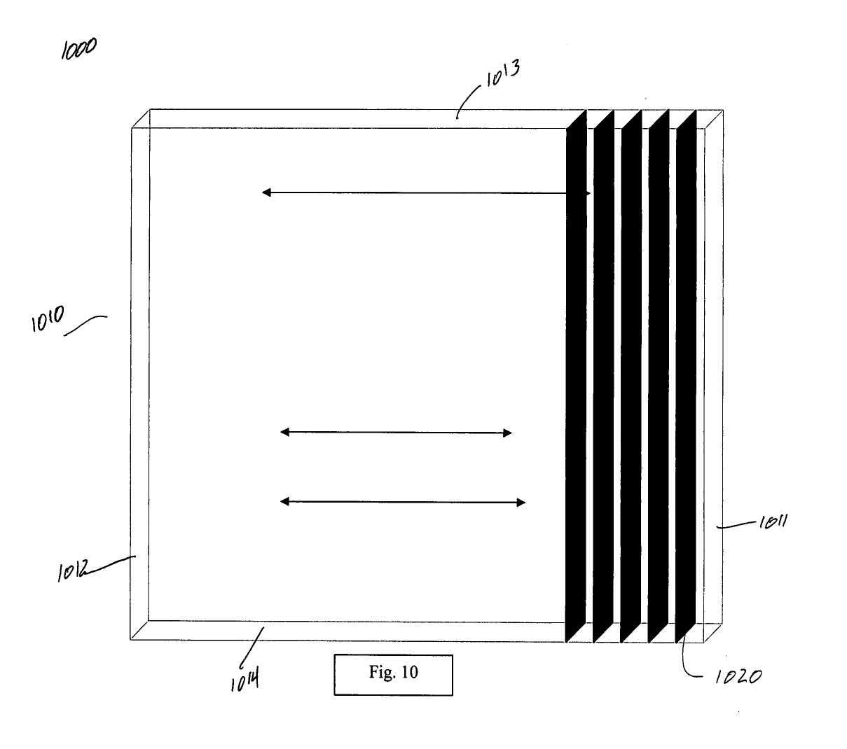

FIG. 10 illustrates shutter assembly 1000 comprising window frame 1010 described under FIG. 1A, a plurality of rotatable flat plats 1020 described under FIG. 4C. Window Frame 1010 has a right side 1011, a left side 1012 a top side 1013 and a bottom side 1014. The plurality of rotatable flat plats 1020 include pins 405 and 406 (not shown) that can be received by the railing on the inner side of the frame 1010 as described in FIG. 4A. According to this embodiment of the present invention the plurality of the plurality of flat plats 1020 are loosely coupled to the top side of window frame 1010. The pins 405 and 406 are received by the top side 1013 and the bottom side 1014. The plurality of flat plats 1020 can be moved eastwardly and positioned substantially close 1011 or westwardly and positioned substantially close next to side 1012. Accordingly the opening of the window is enlarged to the maximum allowing light and air to flow in and out of the enclosure.

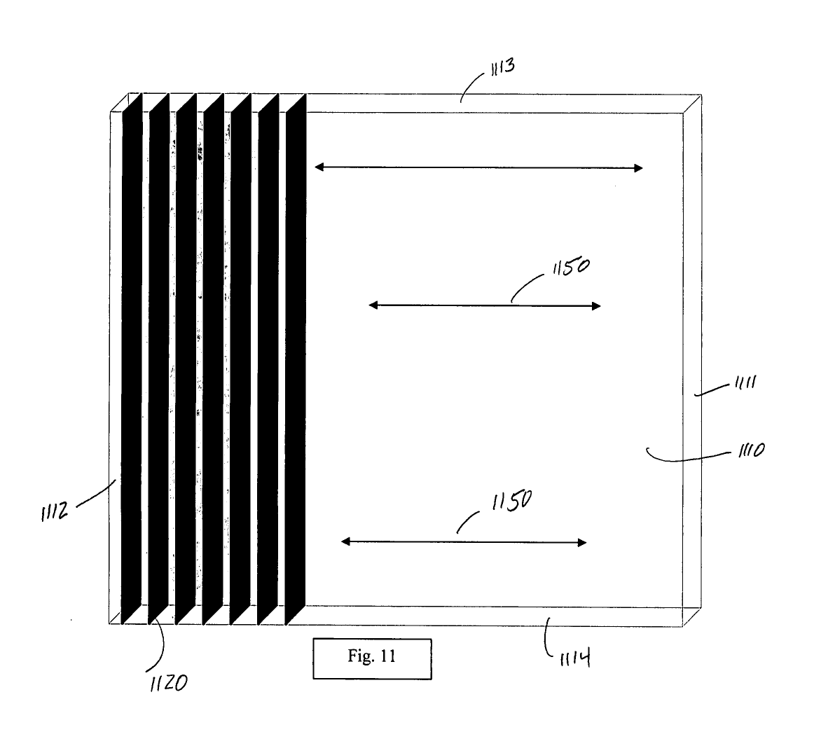

FIG. 11 depicts another embodiment of the present invention, shutter assembly 1100 comprising window frame 1110 described under FIG. 1A, a plurality of rotatable flat plats 1120 described under FIG. 4C. Window Frame 1110 has a right side 1111, a left side 1112 a top side 1013 and a bottom side 1114, where flat plats 1120 are installed in a vertical position and at least one flat plat of the plurality of the flat plat 1120 is positioned close to one side of the frame 1112 and the rest are positioned substantially against the other side of the frame. A user can move the plurality of flat plats 1120 westwardly or eastwardly in the direction 1150 causing the opening to open to a desired opening

While this invention is susceptible of embodiment in many different forms, there is shown in the drawings and will herein be described in detail specific embodiment, with the understanding that the present disclosure is to be considered as an example of the principles of the invention and not intended to limit the invention to the specific embodiment shown and described. In the description below, like reference numerals are used to describe the same, similar or corresponding parts in the several views of the drawings.

In summary, the embodiments of the present invention provide a shutter assembly that provides a shield against unwanted light, air flow or penetration of dust inside an enclosure. Furthermore different embodiment of the present invention provide a user with a shutter assembly which does not protrude inside the enclosure while shield the enclosure against unwanted light, air flow or dust penetration. The present invention further provides a user to use material that can be decorative as well as being protective.

The foregoing description of specific embodiment of the present invention has been presented for purpose of illustration and description. They are not intended to be exhaustive or to limit the invention to the precise form disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A shutter assembly comprising of:
a plurality of stiles;
a plurality of rails wherein said plurality of rail is coupled with said plurality of stiles to form a substantially rectangular frame;
a plurality of stationary flat plats wherein said plurality of stationary flat plats is coupled to said substantially rectangular frame;
a plurality of moveable flat plats wherein said plurality of moveable flat plats is loosely coupled to said substantially rectangular frame;
means for sliding said plurality of moveable flat plats upwardly or downwardly wherein said means for moving said plurality of flat plats is loosely coupled to said plurality of moveable flat plats.

2. A shutter assembly as described in claim 1 wherein said plurality of stationary flat plats are made of wood.

3. A shutter assembly as described in claim 1 wherein said plurality of stationary flat plats are made of metal.

4. A shutter assembly as described in claim 1 wherein said plurality of stationary flat plats are made of cloth.

5. A shutter assembly as described in claim 1 wherein said plurality of stationary flat plats are made of plastic material.

6. A shutter assembly as described in claim 1 wherein said plurality of stationary flat plats having a first and a second surface both faces are decorated with a plurality of designs.

7. A shutter assembly as described in claim 1 wherein said means for moving said plurality of moveable flat plats is a motorized device.

8. A shutter assembly as described in claim 1 wherein said motorized device for moving said plurality of moveable flat plats is remotely controlled.

9. A shutter assembly as described in claim 1 wherein said motorized device for moving said plurality of moveable flat plats is light sensitive

10. A shutter assembly as described in claim 1 wherein said motorized device for moving said plurality of moveable flat plats is temperature sensitive.

11. A shutter assembly as described in claim 1 wherein said motorized device for moving said plurality of moveable flat plats is sound sensitive.

12. A shutter assembly as described in claim 1 wherein said plurality of moveable flat plats are installed horizontally.

13. A shutter assembly as described in claim 1 wherein said plurality of moveable flat plats are installed vertically.

14. A shutter assembly as described in claim 1 wherein said plurality of stationary flat plats are installed horizontally.

15. A shutter assembly as described in claim 1 wherein said plurality of stationary flat plats are installed vertically.

16. A method for forming a combination shutter system and architectural feature unitizing a system in a rectangular bracket for insertion into a building opening comprising: a rectangular frame having an opening comprising a periphery defined by an upper member, a lower member, and opposite side frames extending between the edges of said upper and lower members, a series of plat members with a length governed by the tallness of the building opening, the plat members are installed vertically and are loosely coupled to the upper and lower members; the plat member are movable horizontally to a position substantially attached to the side members of the rectangular bracket.

17. A method for forming a combination shutter system and architectural feature as described in claim 16 wherein the plat members are installed horizontally and are loosely coupled to the opposite side frames with length governed by the width of the building opening; the plat member are movable vertically to a position substantially attached to the opposite side frames of the rectangular bracket.

18. A method for forming a combination shutter system and architectural feature as described in claim 17 wherein a substantial number of said loosely attached louvers are stacked against the upper member and the rest of the louvers are substantially stacked against the lower member in open position allowing maximum air and light inside the building.

19. A method for forming a combination shutter system and architectural feature as described in claim 17 wherein a substantial number of said loosely attached louvers are stacked against one of the opposite sides of the frame member and the rest of the louvers are substantially stacked against the opposite side of the frame member in open position allowing maximum air and light inside the building.
